(19) United States
(12) Patent Application Publication
(10) Pub. No.: US 2015/0124677 A1
(43) Pub. Date: May 7, 2015

(54) DEFINITION OF DIFFERENT NDP PS-POLL TYPES

(71) Applicant: QUALCOMM Incorporated, San Diego, CA (US)

(72) Inventor: Alfred ASTERJADHI, San Diego, CA (US)

(21) Appl. No.: 14/531,969

(22) Filed: Nov. 3, 2014

Related U.S. Application Data
(60) Provisional application No. 61/899,878, filed on Nov. 4, 2013.

(51) Int. Cl. H04W 72/04; H04W 52/02

(52) U.S. Cl. CPC H04W 72/0406; H04W 52/0235
USPC 370/311; 370/329

(57) ABSTRACT

A method, an apparatus, and a computer program product for wireless communication are provided. In one aspect, an apparatus includes a processor configured to indicate first information via a field of a control frame. The processor further indicates second information different from the first information via the field. The apparatus may also include an interface (e.g., circuitry) for providing the control frame for transmission. The control frame may be a null data packet (NDP) power save (PS)-poll frame.

### CROSS-REFERENCE TO RELATED APPLICATION(S)

This application claims the benefit of U.S. Provisional Application Ser. No. 61/899,878, entitled “DEFINITION OF DIFFERENT NDP PS-POLL TYPES” and filed on Nov. 4, 2013, which is expressly incorporated by reference herein in its entirety.

### BACKGROUND

1. Field

The present disclosure relates generally to communication systems, and more particularly, to defining different null data packet (NDP) power save (PS)-poll types in a wireless communication system.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved narrowband channel selection for devices in a wireless network.

One aspect of this disclosure provides an apparatus for wireless communication including a processor and an interface (e.g., circuitry). The processor is configured to indicate first information via a field of a control frame and indicate second information different from the first information via the field. The interface is configured to provide the control frame for transmission. The control frame may be a null data packet (NDP) power save (PS)-poll frame.

Another aspect of this disclosure provides a method of wireless communication at an apparatus including: indicating first information via a field of a control frame, indicating second information different from the first information via the field, and providing the control frame for transmission. The control frame may be a null data packet (NDP) power save (PS)-poll frame.

One aspect of this disclosure provides an apparatus for wireless communication including: means for indicating first information via a field of a control frame, means for indicating second information different from the first information via the field, and means for providing the control frame for transmission. The control frame may be a null data packet (NDP) power save (PS)-poll frame.

Another aspect of this disclosure provides a computer program product for wireless communications at an apparatus, the computer program product comprising a computer-readable medium having instructions executable to: indicate first information via a field of a control frame, indicate second information different from the first information via the field, and provide the control frame for transmission. The control frame may be a null data packet (NDP) power save (PS)-poll frame.

A further aspect of this disclosure provides a station for wireless communication using a control frame. The station includes at least one antenna, a processing system, and an interface (e.g., circuitry). The processing system is configured to indicate via the at least one antenna first information via a field of the control frame, and indicate second information different from the first information via the field. The interface is configured to provide the control frame for transmission.

One aspect of this disclosure provides an apparatus for wireless communication including a processor and an interface (e.g., circuitry). The processor is configured to determine a set of bits in a field of a control frame associated with first information, define a subset of the set of bits for indicating the first information, and indicate second information different from the first information via at least one bit of the set of bits that are not in the defined subset. The interface is configured to provide the control frame for transmission.

Another aspect of this disclosure provides a method of wireless communication at an apparatus including: determining a set of bits in a field of a control frame associated with first information, defining a subset of the set of bits for indicating the first information, indicating second information different from the first information via at least one bit of the set of bits that are not in the defined subset, and providing the control frame for transmission.

One aspect of this disclosure provides an apparatus for wireless communication including: means for determining a set of bits in a field of a control frame associated with first information, means for defining a subset of the set of bits for indicating the first information, means for indicating second information different from the first information via at least one bit of the set of bits that are not in the defined subset, and means for providing the control frame for transmission.

Another aspect of this disclosure provides a computer program product for wireless communications at an apparatus, the computer program product comprising a computer-readable medium having instructions executable to: determine a set of bits in a field of a control frame associated with first information, define a subset of the set of bits for indicating the first information, indicate second information different from the first information via at least one bit of the set of bits that are not in the defined subset, and provide the control frame for transmission.

A further aspect of this disclosure provides a station for wireless communication using a control frame. The station includes at least one antenna, a processing system, and an interface (e.g., circuitry). The processing system is configured to determine a set of bits in a field of a control frame associated with first information, define a subset of the set of bits for indicating the first information, and indicate via the at least one antenna second information different from the first information via at least one bit of the set of bits that are not in the defined subset. The interface is configured to provide the control frame for transmission.

### BRIEF DESCRIPTION OF THE DRAWINGS

FIG. 1 shows an example wireless communication system in which aspects of the present disclosure may be employed.

FIG. 2 shows a functional block diagram of an example wireless device that may be employed within the wireless communication system of FIG. 1.

FIG. 3A illustrates an example wireless communication timeline.

FIG. 3B illustrates an example wireless communication timeline.

FIG. 4 illustrates an example wireless communication timeline.

FIG. 5 illustrates an example wireless communication timeline.

FIG. 6A is a flowchart of an example method of wireless communication.

FIG. 6B is a flowchart of an example method of wireless communication.

FIG. 7 is a functional block diagram of an example wireless communication device.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals in a sub-gigahertz band may be transmitted according to the 802.11ah protocol using orthogonal frequency-division multiplexing (OFDM), direct-sequence spread spectrum (DSSS) communications, a combination of OFDM and DSSS communications, or other schemes. Further, wireless signals may be transmitted in 802.11ah narrowband 1 MHz or 2 MHz channels, for instance. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (“APs”) and clients (also referred to as stations, or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a WiFi (e.g., IEEE 802.11 protocol such as 802.11ah) compliant wireless link to obtain general connectivity to the Internet or to other wide area networks. In some implementations a STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain devices described herein may implement the 802.11ah standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

Wireless nodes, such as stations and APs, may interact in a Carrier Sense Multiple Access (CSMA) type network, such as a network that conforms to the 802.11ah standard. CSMA is a probabilistic Media Access Control (MAC) protocol. “Carrier Sense” describes the fact that a node attempting to transmit on a medium may use feedback from its receiver to detect a carrier wave before trying to send its own transmission. “Multiple Access” describes the fact that multiple nodes may send and receive on a shared medium. Accordingly, in a CSMA type network, a transmitting node senses the medium and if the medium is busy (i.e., another node is transmitting on the medium), the transmitting node will defer its transmission to a later time. If, however, the medium is sensed as free, then the transmitting node may transmit its data on the medium.

Clear Channel Assessment (CCA) is used to determine the state of the medium before a node attempts to transmit thereon. The CCA procedure is executed while a node's receiver is turned on and the node is not currently transmitting a data unit such as a packet. A node may sense whether the medium is clear by, for example, detecting the start of a packet by detecting the packet's PHY preamble, which may be referred to as preamble detection. Further, the node may estimate a defer time or delay time from a Response Indication in a signal (SIG) field, for instance. The preamble detection method may detect relatively weaker signals. Accordingly, there is a low detection threshold with this method. An alternative method is to detect some energy on the air, which may be referred to as energy detection. Energy detection may be used to sense one or more channels at one time. The energy detection method is relatively more difficult than detecting the start of a packet and may only detect relatively stronger signals. As such, there is higher detection threshold with this method relative to preamble detection. In general, detection of another transmission on the medium is a function of the received power of the transmission, where the received power is the transmitted power minus the path loss.

While CSMA is particularly effective for mediums that are not heavily used, performance degradation may occur where the medium becomes crowded with many devices trying to access it simultaneously. When multiple transmitting nodes try to use the medium at once, collisions between the simultaneous transmissions may occur and transmitted data may be lost or corrupted. Because with wireless data communications it is generally not possible to listen to the medium while transmitting on it, collision detection is not possible. Further, transmissions by one node are generally only received by other nodes using the medium that are in range of the transmitting node. This is known as the hidden node problem, whereby, for example, a first node wishing to transmit to and in range of a receiving node, is not in range of a second node that is currently transmitting to the receiving node, and therefore the first node cannot know that the second node is transmitting to the receiving node and thus occupying the medium. In such a situation, the first node may sense that the medium is free and begin to transmit, which may then cause a collision and lost data at the receiving node. Accordingly, collision avoidance schemes are used to improve the performance of CSMA by attempting to divide access to the medium up somewhat equally among all transmitting nodes within a collision domain. Notably, collision avoidance differs from collision detection due to the nature of the medium, in this case the radio frequency spectrum.

In a CSMA network utilizing collision avoidance (CA), a node wishing to transmit first senses the medium and if the medium is busy then it defers or delays (i.e., does not transmit) for a period of time. The period of deferral is followed by a randomized backoff period (i.e., an additional period of time in which the node wishing to transmit will not attempt to access the medium). The backoff period is used to resolve contention between different nodes trying to access a medium at the same time. The backoff period may also be referred to as a contention window. Backoff requires each node trying to access a medium to choose a random number in a range and wait for the chosen number of time slots before trying to access the medium, and to check whether a different node has accessed the medium before. The slot time is defined in such a way that a node will always be capable of determining if another node has accessed the medium at the beginning of the previous slot. In particular, the 802.11 standard uses an exponential backoff algorithm wherein each time a node chooses a slot and collides with another node, it will increase the maximum number of the range exponentially. If, on the other hand, a node wishing to transmit senses the medium as free for a specified time (e.g., the Distributed Inter Frame Space (DIFS) in the 802.11 standard, or Point Coordination Function Inter Frame Space (PIFS) in other cases), then the node is allowed to transmit on the medium. After transmitting, the receiving node may perform a cyclic redundancy check (CRC) of the received data and send an acknowledgement back to the transmitting node. Receipt of the acknowledgment by the transmitting node will indicate to the transmitting node that no collision has occurred. Similarly, no receipt of an acknowledgment at the transmitting node will indicate that a collision has occurred and that the transmitting node should resend the data.

Additionally, a wireless network may implement virtual carrier sensing whereby a node wishing to transmit will first transmit a short control packet called a Request to Send (RTS) to a receiving node. The RTS may include a source, destination and duration of the transmission, including the responsive acknowledgment. If the medium is free, the receiving node will respond with a Clear to Send (CTS) message, which may include the same information as the RTS. Any node within range of either the RTS or CTS will set its virtual carrier sense indicator (also called Network Allocation Vector (NAV)) for the given duration and will defer from attempting to transmit on the medium during that period. Thus, implementing virtual carrier sensing reduces the probability of a collision at the receiving node by a hidden transmitting node. Use of RTS and CTS may also reduce overhead because the RTS and CTS message frames are relatively shorter than the full message frame intended to be transmitted by the transmitting node. That is, because the transmitting node may send an RTS and not receive a CTS, indicating that the receiver is busy, it has used less medium time as compared to sending a full data frame and not receiving an acknowledgement.

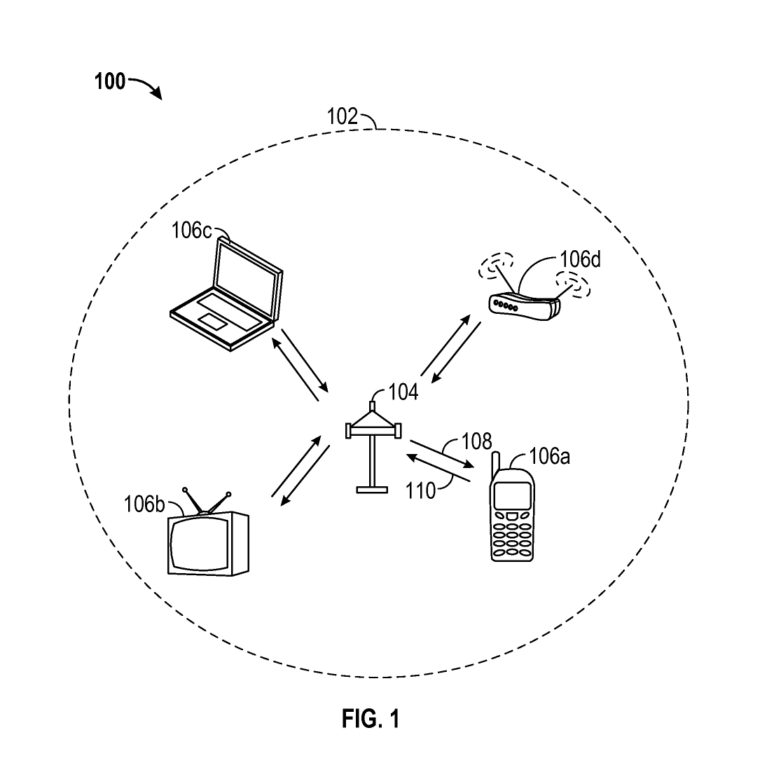

FIG. 1 shows an example wireless communication system 100 in which aspects of the present disclosure may be employed. The wireless communication system 100 may operate pursuant to a wireless standard, for example the 802.11ah standard. The wireless communication system 100 may include an AP 104, which communicates with STAs 106.

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

The AP 104 may transmit on one or more channels (e.g., multiple narrowband channels, each channel including a frequency bandwidth) a beacon signal (or simply a “beacon”), via a communication link such as the downlink 108, to other nodes STAs 106 of the system 100, which may help the other nodes STAs 106 to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information both common (e.g., shared) amongst several devices, and information specific to a given device.

In some aspects, a STA 106 may be required to associate with the AP 104 in order to send communications to and/or receive communications from the AP 104. In one aspect, information for associating is included in a beacon broadcast by the AP 104. To receive such a beacon, the STA 106 may, for example, perform a broad coverage search over a coverage region. A search may also be performed by the STA 106 by sweeping a coverage region in a lighthouse fashion, for example. After receiving the information for associating, the STA 106 may transmit a reference signal, such as an association probe or request, to the AP 104. In some aspects, the AP 104 may use backhaul services, for example, to communicate with a larger network, such as the Internet or a public switched telephone network (PSTN).

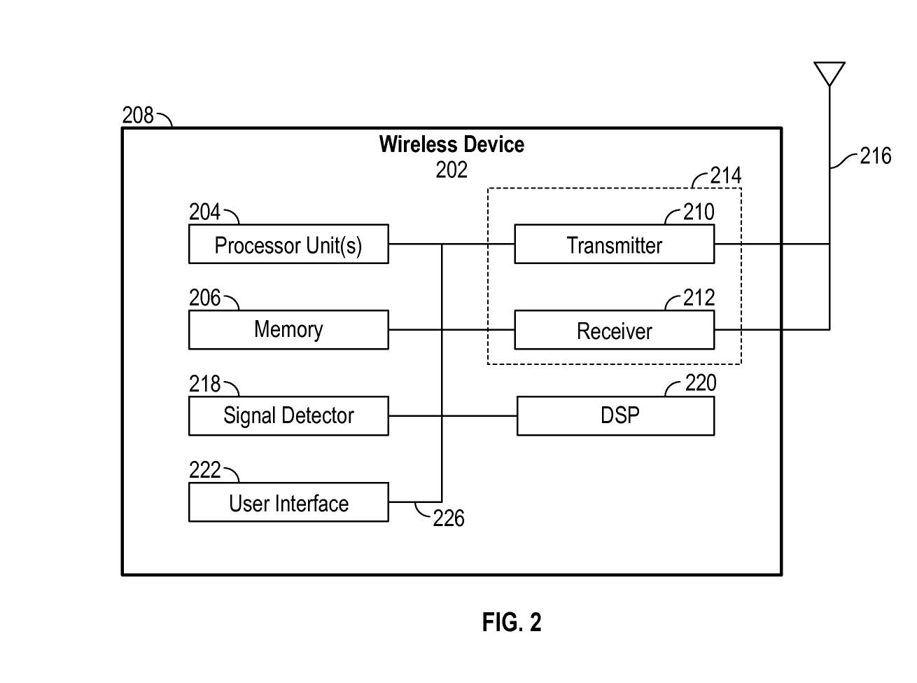

FIG. 2 shows an example functional block diagram of a wireless device 202 that may be employed within the wireless communication system 100 of FIG. 1. The wireless device 202 is an example of a device that may be configured to implement the various methods described herein. For example, the wireless device 202 may comprise the AP 104 or one of the STAs 106.

The wireless device 202 may include a processor 204 which controls operation of the wireless device 202. The processor 204 may also be referred to as a central processing unit (CPU). Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and/or a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The transmitter 210 may be configured, for example, to wirelessly transmit messages, such as polling messages that are configured to retrieve traffic pending and buffered for a device at another device. For example, the transmitter 210 may be configured to transmit polling messages generated by the processor 204, discussed above. When the wireless device 202 is implemented or used as an AP 104, the processor 204 may be configured to process polling messages. When the wireless device 202 is implemented or used as a STA 106, the processor 204 may also be configured to generate polling messages. The receiver 212 may be configured to wirelessly receive polling messages, for example.

Moreover, when the wireless device 202 is implemented or used as a STA 106, the processor 204 and/or the transmitter 210 may be configured to indicate to the AP 104 first information via a field of a control frame, and indicate to the AP 104 second information different from the first information via the field of the control frame. The processor 204 may further provide the control frame for transmission via an interface. In one example, the interface may be circuitry executed by the processor 204.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a packet for transmission. In some aspects, the packet may comprise a physical layer data unit (PPDU).

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Components of the wireless device 202 may be coupled together or accept or provide inputs to each other using some other mechanism.

Although a number of separate components are illustrated in FIG. 2, one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

The wireless device 202 may comprise an AP 104 or a STA 106, and may be used to transmit and/or receive various communications including polling messages, beacon signals, or paging messages, for example. That is, either AP 104 or STA 106 may serve as transmitter or receiver of polling messages, beacon signals, or paging messages. Certain aspects contemplate signal detector 218 being used by software running on memory 206 and processor 204 to detect the presence of a transmitter or receiver. The AP 104 and STA 106 may receive or transmit messages on one or more channels for narrowband communication. For example, the AP 104 and STA 106 may support wireless communication on eight or sixteen channels where each channel is a 1 MHz or 2 MHz frequency band.

The STA 106 (FIG. 1) may have a plurality of operational modes. For example, the STA 106 may have a first operational mode referred to as an active mode. In the active mode, the STA 106 may be in an “awake” state and actively transmit/receive data with the AP 104. Further, the STA 106 may have a second operational mode referred to as a power save mode. In the power save mode, the STA 106 may be in the “awake” state or a “doze” or “sleep” state where the STA 106 does not actively transmit/receive data with the AP 104. For example, the receiver 212 and possibly DSP 220 and signal detector 218 of the STA 106 may operate using reduced power consumption in the doze state. Further, in the power save mode, the STA 106 may occasionally enter the awake state to listen to messages from the AP 104 (e.g., paging messages configured to indicate to wireless devices whether or not the wireless devices have traffic pending and buffered at another device) that indicate to the STA 106 whether or not the STA 106 needs to “wake up” (e.g., enter the awake state) at a certain time so as to be able to transmit/receive data with the AP 104.

Accordingly, in certain wireless communication systems 100 (FIG. 1), the AP 104 may transmit paging messages to a plurality of STAs 106 in a power save mode in the same network as the AP 104, indicating whether or not the STAs 106 need to be in an awake state or a doze state. For example, if a STA 106 determines it is not being paged it may remain in a doze state. Alternatively, if the STA 106 determines it may be paged, the STA 106 may enter an awake state for a certain period of time to receive the page and further determine when to be in an awake state based on the page. Further, the STA 106 may stay in the awake state for a certain period of time after receiving the page. In another example, the STA 106 may be configured to function in other ways when being paged or not being paged that are consistent with this disclosure. For example, the page may indicate that the STA 106 should enter an awake state for a certain period of time because the AP 104 has data to transmit to the STA 106. The STA 106 may poll the AP 104 for data by sending the AP 104 a polling message when in the awake state for the period of time. In response to the polling message, the AP 104 may transmit the data to the STA 106.

In some aspects, paging messages may comprise a bitmap (not shown), such as a traffic identification map (TIM). In certain aspects, the bitmap may comprise a number of bits. These paging messages may be sent from the AP 104 to STAs 106 in a beacon or a TIM frame. Each bit in the bitmap may correspond to a particular STA 106 of a plurality of STAs 106, and the value of each bit (e.g., 0 or 1) may indicate whether the particular STA 106 has traffic pending and buffered at the AP 104.

Still referring to FIG. 1, the STA 106 may estimate the quality of one or more channels based on one or more messages received from the AP 104. For example, in some implementations the STA 106 may receive a beacon signal, paging message, or a partial packet including a preamble portion on one or more of eight different 2 MHz channels or one or more of 16 different 1 MHz channels from the AP 104. The STA 106 may estimate the signal to noise ratio for one or more of the 1 MHz or 2 MHz channels based on the received message. The greater the signal to noise ratio, the higher the estimated quality of the channel determined by the STA 106. Accordingly, the STA 106 may then determine the relative quality of multiple channels based at least in part on the estimated quality of each channel. In some aspects, the STA 106 may listen to more than one channel simultaneously to estimate the quality of each channel.

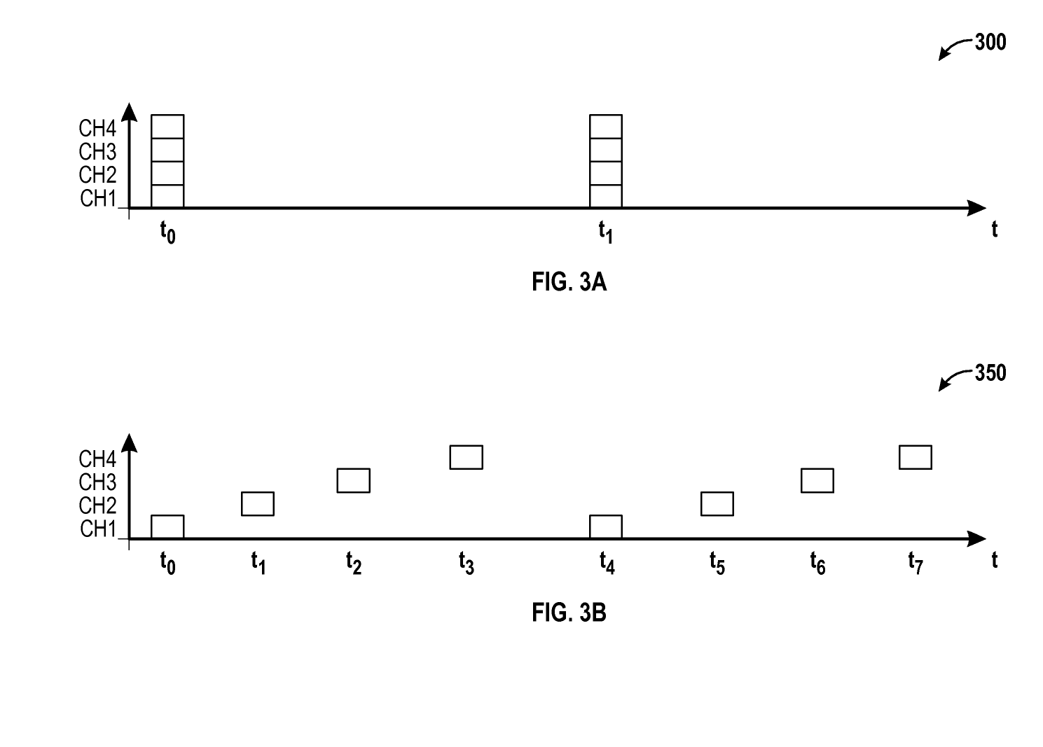

Also, in some aspects, the STA 106 may utilize different approaches to estimate the quality of channels depending on an operating mode of an AP 104 or channel conditions. For instance, if the AP 104 changes channels infrequently (e.g., coherence time>>beacon interval), the STA 106 may estimate the quality of one or more channels based on a beacon signal. If the AP 104 changes channels frequently (e.g., coherence time≈beacon interval), the STA may estimate the quality of one or more channels based on a Null Data packet (NDP) transmitted by the AP 104. Further, in some aspects, the AP 104 may reserve a channel estimation period following a beacon signal. During the channel estimation period, the AP 104 may, for example, send NDPs over one or more channels. The AP 104 may send NDPs or beacon frames over all or a portion of the one or more channels simultaneously (for example, in all 1 MHz or 2 MHz channels), as illustrated in communication timeline 300 of FIG. 3A. For instance, the AP 104 may transmit NDPs or beacon frames simultaneously on channels 1 (CH1), 2 (CH2), 3 (CH3), and 4 (CH4) at times t₀ and t₁. In some implementations, the AP 104 may send one or more NDPs over the one or more channels at different times, as illustrated in communication timeline 350 of FIG. 3B. For instance, the AP 104 may transmit one NDP on CH1 at time t₀, another NDP on CH2 at time t₁, and continue to transmit one NDP on one channel through times t₂, t₃, t₄, t₅, t₆, and t₇. In some implementations, the AP 104 may send one or more beacon frames over the one or more channels at different Target Beacon transmit times (TBTTs). For instance, the AP 104 may transmit one beacon frame on CH1 at time t₀, another beacon frame CH2 at time t₁, and continue to transmit one beacon frame on one channel through times t₂, t₃, t₄, t₅, t₆, and t₇.

In some implementations, the AP 104 may be configured to receive packets on any channel at any time. In some implementations, an AP 104 with an operating bandwidth greater than 2 MHz may operate by setting its primary channel on one of the 1 or 2 MHz channels within its operating bandwidth. The AP 104 may also be configured to receive only packets on a primary channel. If the AP 104 is configured to receive packets on any channel, the STA 106 may be configured to commence transmitting to AP 104 at any time on any channel, without having to indicate which channel may be used. If the AP 104 is configured to receive packets on only the primary channel, the STA 106 may be configured to indicate to the AP 104 on which channel the STA 106 will transmit to the AP 104, using a configuration packet or another method.

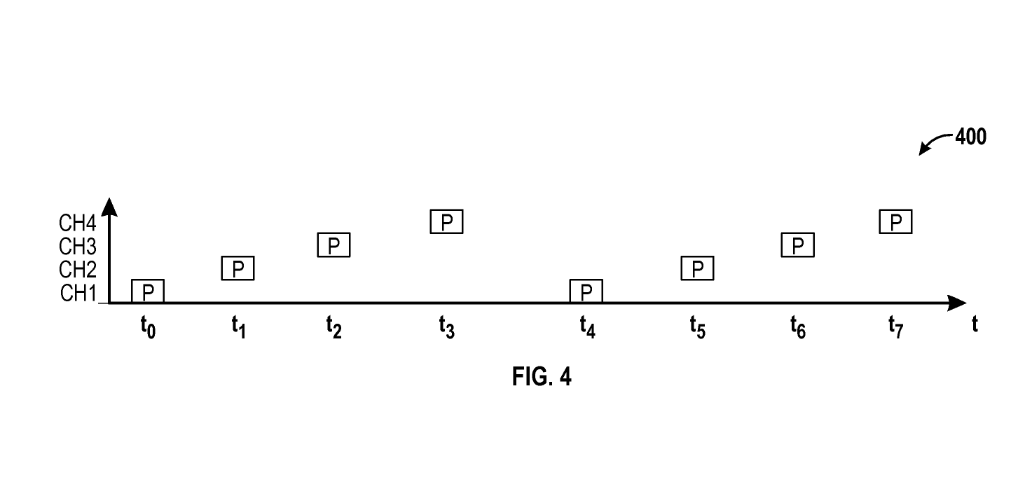

The AP 104 may use the same channel as a primary channel, such as a pre-negotiated or pre-defined frequency band (e.g., the lowest frequency band channel) of a plurality of channels, or may change primary channels. The AP 104 may, for example, change which channel is the primary channel during regularly-spaced intervals or during other intervals which may not be regularly-spaced. In some implementations, the AP 104 may send an NDP or a beacon frame over each channel individually in regularly-spaced intervals, and may use the channel that it most recently sent an NDP or a beacon frame over as the primary channel, until the next NDP or beacon frame is sent on another channel, as illustrated in communication timeline 400 of FIG. 4. For instance, the AP 104 may transmit one NDP or beacon frame on CH1 at time t₀, another NDP on CH2 at time t₁, and continue to transmit one NDP on one channel through times t₂, t₃, t₄, t₅, t₆, and t₇ to periodically change the primary channel of the AP 104. The STAs that may be associated with the AP 104 may be informed of the position of the primary channel (either a position of a current primary channel by receiving a frame in that channel or a position of a next primary channel by including information for the next primary channel in the received frame). The switching of the primary channel may be conveyed to the STAs by the AP 104 as a schedule provided at association or later through a management exchange with the STAs. This information may be included in a beacon signal. For example, IEEE (Extended) Channel Switch Announcement frames or other elements (e.g., Subchannel Selective Transmission Element) may be used to indicate the switch from one channel to another. Elements may be enhanced by including information on further future channel switches as well.

A STA 106 may not switch channels when the AP 104 informs the STA 106 of the change of primary channels. Instead, the STA 106 may stay on its selected channel even after the AP 104 has moved to another channel. The STA 106 in this case may not send packets to the AP 104, as the operating channel or channels of the AP 104 may not include the selected channel of the STA 106. The STA 106 may resume operation with the AP 104 as soon as the AP returns the primary channel to a channel which includes the STA 106 operating channel. In some implementations, the AP 104 may not indicate to the STA 106 which channel the AP 104 is switching to. If the STA 106 is not going to switch channels, the AP 104 may alert the STA 106 when the AP 104 will be on the selected channel of the STA 106, rather than alerting the STA 106 of what channel the AP 104 will be on. In some implementations, the AP 104 may indicate when its operation on a channel is starting and ending, such that STAs on a channel will be aware when the AP 104 is on the channel. In this case, the BSS on a given channel may only be active for the portion of time the AP 104 is on that channel. The AP 104 may use the same basic service set identification (BSSID) and service set identification (SSID) on multiple channels, or it may use different BSSIDs for different channels. In addition, the AP 104 may send beacon frames that include different information that depends on the channel where the beacon frame is transmitted.

The STA 106 may select a channel with the highest quality for transmission of messages or data. Advantageously, since 1 MHz or 2 MHz channels may need a higher multipath fading margin due to less frequency diversity than a 20 MHz channel, for instance, a 1 MHz or 2 MHz channel with the highest quality may have a lower multipath fading margin than another channel. Thus, the STA 106 may also be able to successfully transmit data on the selected channel at a higher transmission rate, for example.

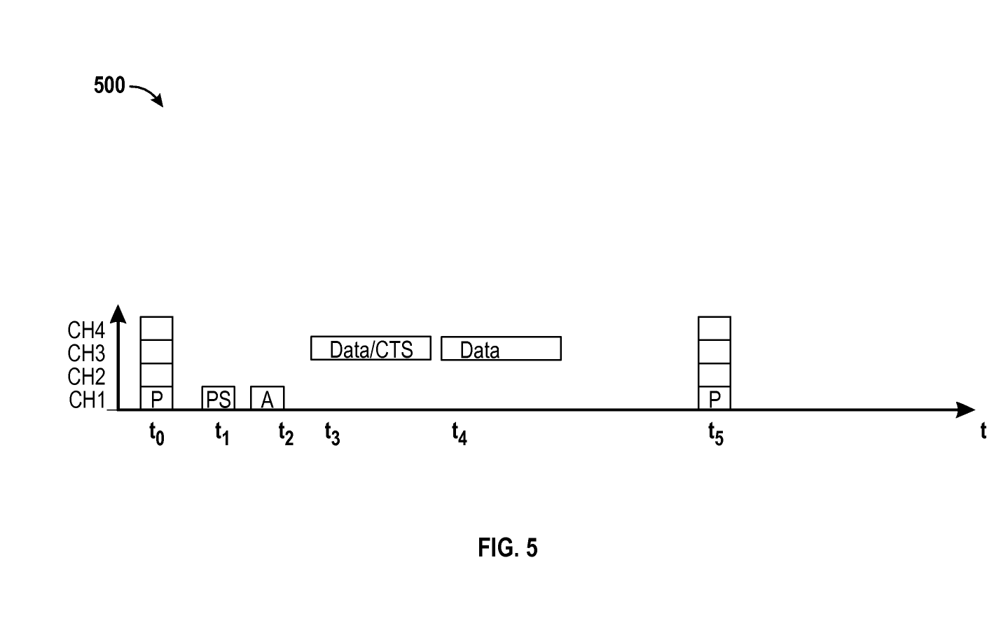

In some aspects, the AP 104 may periodically broadcast a TIM frame or TIM message on one or more channels. The TIM message may indicate that STAs 106 have data buffered at the AP 104. A STA 106 with data buffered may transmit on one or more channels a configuration message including a polling message (e.g., a power-save poll or PS-Poll) to indicate that the STA 106 would like to receive the buffered data on a particular channel from the AP 104. In one aspect, a PS-Poll frame may be a NDP PS-Poll frame. Further, the STA 106 may transmit a packet including a PHY preamble of the configuration message to cause other devices to defer communication on one or more channels. The STA 106 may then wait on the particular channel selected by the STA 106 for the AP 104 to transmit the buffered data. In response to the STA 106 correctly receiving the buffered data from the AP 104, the STA 106 may transmit on one or more channels an acknowledgement message to the AP 104. In one aspect, after the STA 106 sends a polling message indicating the STA 106 would like to receive the buffered data on a particular channel, the STA 106 may wait in the primary channel to receive an ACK from the AP 104. This ACK may agree upon the channel indicated by the STA 106 in the polling message. The AP 104 may then transmit packets to the STA 106 on the preferred channel. For example, the AP 104 may transmit packets to the STA 106 on the channel selected by the STA 106 in the polling message. The AP 104 may transmit these packets immediately after responding with ACK, or may transmit these packets later. For example, in the communication timeline 500 of FIG. 5, the STA 106 may transmit a PS-Poll at time t₁ indicating the selected channel and receive an ACK from the AP 104 at time t₂ agreeing to the selected channel for data exchange. The AP 104 may then transmit packets to the STA 106 at time t₃ and reserve a time period after time t₄ for transmission of data by the STA 106. In one aspect, the STA 106 that transmits the PS-Poll type frame may not need to read the beacon.

In response to the STA 106 correctly receiving the buffered data from the AP 104, when allowed by the AP 104, such as through a reverse direction grant (RDG), the STA 106 may transmit data packets to the AP 104 on one or more channels. The AP 304 may allow the STA 106 to send the data, upon indication that the STA 106 has data pending. This indication may be included in the polling message, such as a PS-Poll.

Several power saving mechanisms for the STA 106 may be defined in the 802.11ah protocol that allows the STA 106 to solicit different types of information from the associated AP 104 using a PS-Poll of different types. The PS-Poll types may be indicated in a Poll Type subfield of a Frame Control (FC) field of a PS-Poll frame. The Poll Type subfield may have the format shown in Table 1 below:

TABLE 1

| Poll Type value | |
|---|---|
| b14 b15 | Description |
| 00 | Requesting a buffered frame without |
| | rescheduling awake/doze cycle |
| 01 | Requesting Change Sequence/Timestamp |
| 10 | Requesting for a duration to a TBTT or |
| | Next TWT to reschedule awake/doze cycle |
| 11 | Requesting for a duration to a service |
| | period to reschedule awake/doze cycle |

The STA 106 may send to the AP 104 a PS-Poll frame with the Poll Type set to a given value. For example, when the STA 106 wakes, the STA 106 may solicit BSS change sequence and/or current timestamp information, or other information, from the AP 104 by sending a polling message (PS-Poll) with the Poll Type field in the Frame Control field set to 1. Alternatively, the STA 106 may solicit information regarding a Next Target Wake Time (TWT) or duration to a Target Beacon Transmit Time (TBTT) by setting the Poll Type field to 2. In addition, the STA 106 that has requested time slot protection for a transmit opportunity (TXOP) duration after expiration of a wakeup timer (e.g., when the AP 104 activates RDG or sends a Synch frame), may transmit a PS-Poll with the Poll Type field set to 3 to indicate such protection (which may be agreed upon a priori with the AP 104 via negotiation).

The AP 104 may respond to the received polling message (PS-Poll) by sending a Target Wake Time Acknowledgment (TACK) which includes a Timestamp field but may not include a Next TWT field. The AP 104 may also send a null data packet (NDP) ACK frame that includes a wakeup timer (e.g., by setting a Duration Indication field in the NDP ACK to 1) set to the duration to the TBTT, or send a TACK frame that includes a Next TWT field set to the value of the TBTT.

In an aspect, the AP 104 that is UL-Synch capable (protects a slot of TXOP duration) may respond with an NDP ACK frame to a PS-Poll with the Poll Type field set to 3. Here, the NDP ACK frame may include a wakeup timer in a duration field (indicated by the Duration Indication field set to 1), and may protect the TXOP that follows after the expiration of the wakeup timer by sending a Synch frame (e.g., NDP CTS frame), for example.

In some implementations, two different types of PS-Poll frames may be used in the 802.11ah protocol: 1) PS-Poll frame; and 2) NDP PS-Poll frame. However, only the PS-Poll frame may include the Poll Type field defined in the Frame Control field, as described above. Hence, the STA 106 that uses the NDP PS-Poll frame cannot benefit from the power saving features described above because no Poll Type field exists for easily indicating the Poll Type. In order for the STA 106 using the NDP PS-Poll frame to benefit from the above-described power saving features, additional signaling may be provided for two subtypes of the NDP PS-Poll frame (e.g., NDP PS-Poll frame (1 MHz) and NDP PS-Poll frame (≧2 MHz)).

The NDP PS-Poll frame (1 MHZ) and the NDP PS-Poll frame (≧2 MHz) may not include a Poll Type field due to a limited number of bits in a SIG field of a PLCP header (e.g., NDP frames populate the SIG field to signal MAC information). The PLCP header may have the format shown in Table 2 below:

TABLE 2

| | NDP MAC | NDP | | |
|---|---|---|---|---|
| | frame body | Indication | CRC | Tail |
| Bits | 25 (37) | 1 | 4 | 6 |

An NDP MAC frame body for an NDP PS-Poll (1 MHz) and NDP PS-Poll (≧2 MHz) may have the format shown in Table 3 below (values in parentheses are for ≧2 MHz frames):

TABLE 3
NDP PS-Poll 1 (≧2) MHz

| | Size | |
|---|---|---|
| Field | (bits) | Description |
| NDP MAC | 3 | Set to 1 for NDP PS-Poll. |
| Frame Type | | |
| Receiver | 9 | Partial AID of receiving AP. |
| Address | | |
| (RA) | | |
| Transmitter | 9 | Partial AID of transmitting STA. |
| Address | | |
| (TA) | | |
| Preferred | TBD | Indicates preferred MCS level [index] of the |
| MCS | (4) | STA for downlink transmission. |
| UDI | 1 | Uplink Data Indication: |
| | (12) | Set to 0 to indicate no uplink data is available, |
| | | Set to 1 to indicate uplink data is available for 1 |
| | | MHz format, or set to non-zero to indicate duration |
| | | of uplink data in TUs for ≧2 MHz format. |
| Reserved | 0 | Reserved for future use. |
| | (0) | |

In some implementations, the NDP PS-Poll frame may be enhanced to enable use of the NDP PS-Poll frame in power saving mechanisms, such as the mechanisms described above. In an aspect, for the NDP PS-Poll frame (1 MHZ) and the NDP PS-Poll frame (≧2 MHz), a number of values (e.g., reserved values) of a Preferred Modulation and Coding Scheme (MCS) field may be used to indicate the Poll Type.

For example, in the NDP PS-Poll frame (1 MHZ), the Preferred MCS field may have a length of 3 bits allowing for a number of possible values. The mapping of the field and the preferred MCS may occupy only a portion of the possible values. For example, values from 0 to 5 of the Preferred MCS field may be used to indicate a preferred MCS level for downlink transmission. Accordingly, the remaining values of the Preferred MCS field (e.g., values from 6 to 8) may be used by the STA 106 to indicate/signal the Poll Type as in Table 1 above.

In another example, in the NDP PS-Poll frame (≧2 MHz), the Preferred MCS field may have a length of 4 bits and an MCS index may occupy a number of values from 0 to 9. Therefore, reserved values from 10 to 15 may be used by the STA 106 to indicate/signal the Poll Type according to mapping similar to the mapping described in Table 1 above (e.g., Preferred MCS values set to 10, 11, 12, and 13 in Table 3 respectively correspond to Poll Type values set to 0, 1, 2, and 3 in Table 1).

In another aspect, for the NDP PS-Poll frame (≧2 MHz), a number of values (e.g., reserved values) of an Uplink Data Indication (UDI field) may be used to indicate the Poll Type. The UDI field indicates in multiples of time units (TUs) a duration of uplink data that the STA 106 has buffered for the AP 104. For example, a TU of 8 μs is sufficient to indicate a duration of up to 32 ms, which is a maximum duration that the NAV can set, and well within a MaxPPDUTxTime of 27 ms for the 802.11ah protocol. Hence, certain values of the UDI field may be used to indicate the Poll Type. For example, when the UDI field is set to a value of 2 in Table 3, the UDI field may indicate the Poll Type set to a value of 0 in Table 1. Similarly, the UDI field being set to values of 3, 4, and 5 in Table 3 may respectively indicate the Poll Type set to values of 1, 2, and 3 in Table 1. Notably, the values of 2, 3, 4, and 5 of the UDI field are not used in some implementations as they indicate PPDU durations on the order of several tens of microseconds, and a minimum PPDU duration for the NDP PS-Poll frame (≧2 MHz) is 240 μs (minimum time for transmitting the PLCP header).

In some implementations, a Poll Type field may be defined for a NDP PS-Poll frame using the same indications (or a subset of the indications) as Table 1 above. To define the Poll Type field for the NDP PS-Poll frame (≧2 MHz), the UDI field may be reduced to a length of 10 bits and the TU can be increased to 32 μs. Similarly, to define the Poll Type field for the NDP PS-Poll frame (1 MHz), the Preferred MCS field may be modified such that one or more bits may be used for indicating a map of the Preferred MCS and one or more bits may be used for indicating the Poll Type. As an example, 1 bit may be used to indicate the Poll type and 2 bits may be used to indicate the Preferred MCS with some signaling restrictions (e.g., only a certain subset of the Preferred MCS may be signaled).

In other aspects, any of the fields of the NDP PS-Poll frame may be reduced to make space for a Poll type field of one or more bits which may be needed to provide the required signaling as described in the teachings herein.

In one aspect, the Poll type signaling for the NDP PS-Poll frame (1 MHz) may indicate whether the STA 106 transmitting the NDP PS-Poll frame (1 MHz) requests an intended receiver to respond with an acknowledgement frame that has a Duration field that indicates a sleep period (similar to the operation associated with the Poll type value of 11 in Table 1) or with an acknowledgement frame that includes an ID extension in the Duration field. As an example, the response to the NDP PS-Poll frame may be a NDP (Modified) ACK. In one aspect, the NDP (Modified) ACK may include a Duration Indication field set to 0 and a Duration field that includes an ID extension for the NDP (Modified) ACK. For example, the Duration field may include a bit sequence that is derived from the TA and the RA address of the eliciting NDP PS-Poll frame (e.g., the sequence may be TA(3) concatenated with RA[0:8]) if the Poll type signaling is similar to the Poll Type value 00 in Table 1. In another aspect, the NDP (Modified) ACK may include a Duration Indication field set to 1 and a Duration field set to a duration of time during which an idle period is expected from the STA 106 that generated the NDP PS-Poll to which the ACK is sent as a response if the Poll type signaling is similar to the Poll Type value 11 in the Table 1.

Generally, any combination of the aforementioned methods may be used by the STA 106 to indicate the Poll Type of an NDP PS-Poll frame depending on an availability of bits in the NDP PS-Poll frame.

In an aspect, the aforementioned methods may be used by the STA 106 to indicate or solicit various types of information from the intended receiver. As a non-limiting example, the STA 106 may indicate, using the aforementioned methods, the primary channel the STA 106 plans to be operative during a next Service Period. In such aspect, the STA 106 may send the (NDP) PS-Poll in the primary channel of the BSS with which the STA 106 is operating, and may indicate to an associated AP 104 within the (NDP) PS-Poll, the offset of a temporary primary channel for the next Service Period (the start time of which may have been previously indicated by the AP 104 or indicated in an immediate response that the AP 104 sends to the STA 106 as a response to the NDP PS-Poll.

Notably, while the types of signaling mentioned above is described in the context of PS-Poll frames (of type NDP), the same concepts apply to other types of Null Data Packets (e.g., CTS).

In an aspect, the UDI field provides signaling to the AP 104 similar to a More Data field that exists in the 802.11ah standard. Accordingly, the UDI field for the NDP PS-Poll frame may be renamed as the More Data field and the following operation may be defined to accommodate for the NDP PS-Poll frame: An S1G STA sets the More Data field of a NDP PS-Poll frame (≧2 MHz) to a value greater than 1, to indicate the duration of the data buffered for transmission to the frame's recipient during the current SP or TXOP (in multiples of 8 μs).

Additionally, if UDI field values are used to indicate the Poll type, the following operation may be defined for the More Data field to accommodate for the NDP PS-Poll frame: An S1G STA sets the More Data field of a NDP PS-Poll frame (≧2 MHz) to a value greater than 6, to indicate the duration of the data buffered for transmission to the frame's recipient during the current SP or TXOP (in multiples of 8 μs).

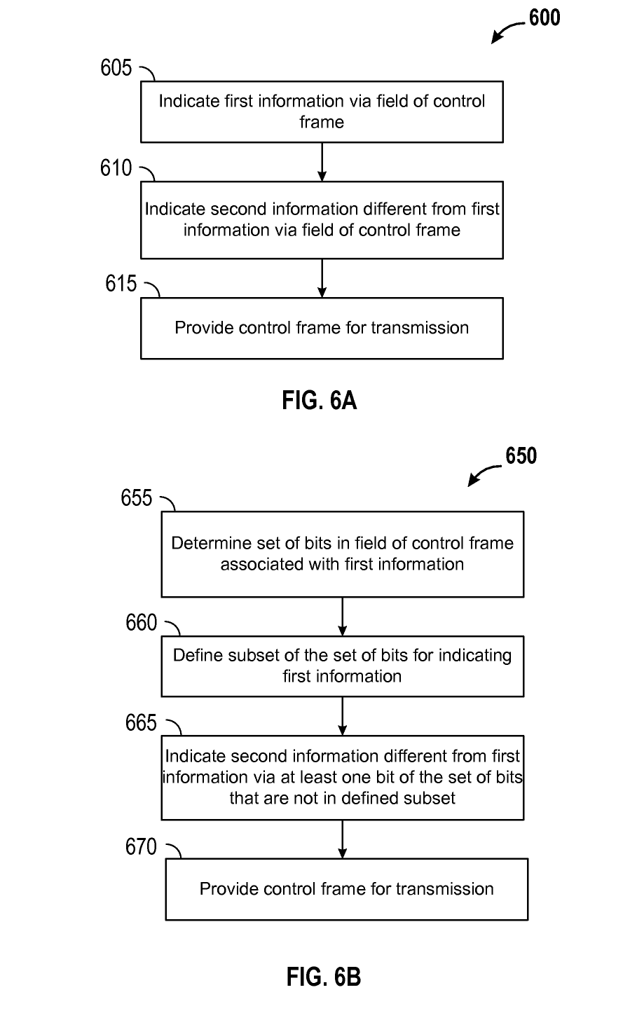

FIG. 6A is a flowchart of an example method 600 of wireless communication using a control frame. The method 600 may be performed using an apparatus (e.g., the wireless device 202 of FIG. 2, for example). Although the process 600 is described below with respect to the elements of wireless device 202 of FIG. 2, other components may be used to implement one or more of the steps described herein.

At block 605, the apparatus may indicate first information via a field of a control frame. The control frame may be, for example, a null data packet (NDP) power save (PS)-poll frame. Indicating the first information may be performed by the processor 204 and/or the transmitter 210, for example.

At block 610, the apparatus may indicate second information different from the first information via the field of the control frame. Indicating the second information may be performed by the processor 204 and/or the transmitter 210, for example. At block 615, the apparatus may provide the control frame for transmission. The control frame may be provided via an interface. In one example, the interface may be circuitry executed by the apparatus.

In an aspect, the first information is a preferred modulation and coding scheme (MCS), the second information is a control frame type, and the field comprises a set of values. Accordingly, the apparatus may indicate the first information by indicating the preferred MCS via a first subset of the set of values, and indicate the second information by indicating the control frame type via a second subset of the set of values. In an aspect, the control frame type facilitates a receiver of the control frame type to transmit an acknowledgment (ACK) frame to the apparatus. The apparatus may receive the transmitted ACK frame. The ACK frame may include a duration field indicating an idle period and/or an ACK identification (ID) extension. In an aspect, if the duration field indicates the idle period, the apparatus may refrain from performing a transmission during the idle period. In a further aspect, if the duration field indicates the ACK ID extension, the apparatus may determine whether the control frame type was successfully indicated to the receiver based on the ACK ID extension.

In another aspect, the first information is an uplink data indication (UDI), the second information is a control frame type, and the field comprises a set of values. Accordingly, the apparatus may indicate the first information by indicating the UDI via a first subset of the set of values, and indicate the second information by indicating the control frame type via a second subset of the set of values. In an aspect, the control frame type indicates an operating channel offset (e.g., an offset of a temporary primary channel for a next service period).

In a further aspect, the first information is a preferred MCS or UDI, the second information is a control frame type, and the field comprises a set of bits. Accordingly, the apparatus may indicate the first information by defining a subset of the set of bits for indicating the first information, and indicate the second information by indicating the control frame type via at least one bit of the set of bits that are not in the defined subset. In some implementations, the first information is the UDI and the set of bits comprises 12 bits. Accordingly, the apparatus may indicate the first information by defining 10 of the 12 bits for indicating the UDI, and indicate the second information by indicating the control frame type via two of the 12 bits that are not defined for indicating the UDI. In some implementations, the first information is the preferred MCS and the subset of bits comprises at least three bits. Accordingly, the apparatus may indicate the first information by defining one bit for indicating the preferred MCS, and indicate the second information by indicating the control frame type via two bits that are not defined for indicating the preferred MCS. Alternatively, the apparatus may indicate the first information by defining two bits for indicating the preferred MCS, and indicate the second information by indicating the control frame type via one bit that is not defined for indicating the preferred MCS.

In yet another aspect, the first information is a preferred MCS or UDI, the second information is an indication of a channel to be used for communication, and the field comprises a set of values. Accordingly, the apparatus may indicate the first information by indicating the first information via a first subset of the set of values, and indicate the second information by indicating the channel to be used for communication via a second subset of the set of values.

FIG. 6B is a flowchart of an example method 650 of wireless communication using a control frame. The method 650 may be performed using an apparatus (e.g., the wireless device 202 of FIG. 2, for example). Although the process 650 is described below with respect to the elements of wireless device 202 of FIG. 2, other components may be used to implement one or more of the steps described herein.

At block 655, the apparatus may determine a set of bits in a field of the control frame associated with first information. For example, the set of bits may be determined based on a number of bits available in the field. In an aspect, the control frame is a null data packet (NDP) power save (PS)-poll frame. The determining may be performed by the processor 204, for example.

At block 660, the apparatus may define a subset of the set of bits for indicating the first information. For example, the subset of the set of bits may be defined based on a number of values associated with the first information. The defining may be performed by the processor 204 and/or the transmitter 210, for example.

At block 665, the apparatus may indicate second information different from the first information via at least one bit of the set of bits that are not in the defined subset. The indicating may be performed by the processor 204 and/or the transmitter 210, for example. At block 670, the apparatus may provide the control frame for transmission. The control frame may be provided via an interface. For example, the interface may be circuitry executed by the apparatus.

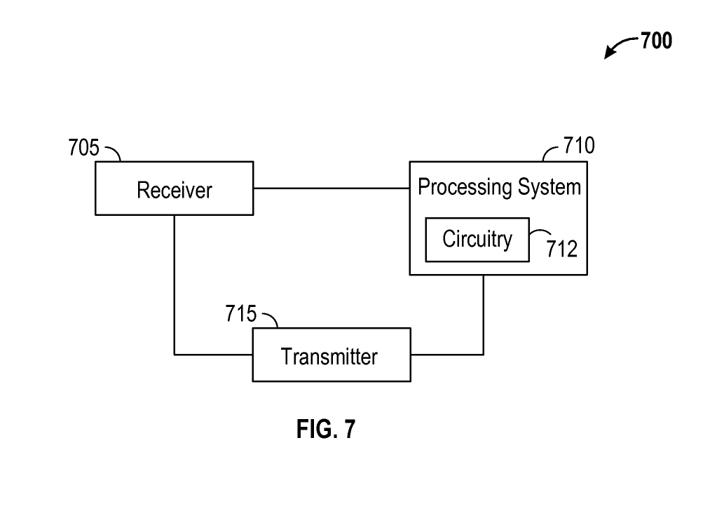

FIG. 7 is a functional block diagram of an example wireless communication device 700. The wireless communication device 700 may include a receiver 705 configured to wirelessly receive messages (e.g., ACK frame) from a second device over a plurality of channels. The receiver 705 may correspond to the receiver 212. The wireless communication device 700 may further include a processing system 710 and a transmitter 715. The processing system 710 and/or the transmitter 715 may be configured to indicate to the second device first information via a field of a control frame, and indicate to the second device second information different from the first information via the field of the control frame. The processing system 710 and/or the transmitter 715 may be configured to perform one or more functions discussed above with respect to blocks 605 and 610 of FIG. 6A. The processing system 710 may correspond to the processor 204. The transmitter 715 may correspond to the transmitter 210. The processing system 710 may include circuitry 712 that operates as an interface for providing the control frame for transmission. The circuitry 712 may be configured to perform one or more functions discussed above with respect to block 615 of FIG. 6A. The processing system 710 may further be configured to determine a set of bits in a field of the control frame associated with first information, and define a subset of the set of bits for indicating the first information. The processing system 710 and/or the transmitter 715 may further be configured to indicate second information different from the first information via at least one bit of the set of bits that are not in the defined subset. The processing system 710 and/or the transmitter 715 may further be configured to perform one or more functions discussed above with respect to blocks 655, 660, and 665 of FIG. 6B. The circuitry 712 may also be configured to perform one or more functions discussed above with respect to block 670 of FIG. 6B.

Moreover, in one aspect, means for indicating first information via a field of the control frame and means for indicating second information different from the first information via the field may comprise the processing system 710 and the transmitter 715 executing one or more algorithms. For example, the processing system 710 may determine the first information and the second information to be indicated. The processing system 710 may then select the control frame in which to carry the first information and the second information. Accordingly, after the first information and second information are determined and the control frame is selected, the transmitter 715 may be executed by the processing system 710 to indicate the first information via a field of the selected control frame and further indicate the second information via the field. In another aspect, means for providing the control frame for transmission may comprise the circuitry 712 and/or the processing system 710 executing one or more algorithms.

In a further aspect, means for determining a set of bits in a field of the control frame associated with first information may comprise the processing system 710 executing one or more algorithms. For example, the processing system 710 may determine the first information. The processing system 710 may then select the control frame associated with the first information. Once the first information is determined and the control frame is selected, the processing system may determine a set of bits in a field of the control frame associated with the first information.

In another aspect, means for defining a subset of the set of bits for indicating the first information may comprise the processing system 710 and the transmitter 715 executing one or more algorithms. For example, as stated above, the processing system may determine a set of bits in a field of the control frame associated with the first information. Thereafter, the processing system 710 may further define a subset of the set of bits to be associated with the first information. The transmitter 715 may then be executed by the processing system 710 to indicate the first information via the defined subset of bits.

In an aspect, means for indicating second information different from the first information via at least one bit of the set of bits that are not in the defined subset may comprise the processing system 710 and the transmitter 715 executing one or more algorithms. For example, as stated above, the processing system 710 may define a subset of the set of bits to be associated with the first information. The processing system 710 may also determine the second information. Once the subset of bits is defined, the processing system 710 may determine at least one bit of the set of bits that are not in the defined subset to be associated with the second information. Thereafter, transmitter 715 may be executed by the processing system 710 to indicate the second information via the at least one bit of the set of bits that are not in the defined subset.

In an aspect, means for receiving an ACK frame may comprise the processing system 710 and the receiver 705 executing one or more algorithms. In a further aspect, means for refraining from performing a transmission during the idle period may comprise the processing system 710 and the transmitter 715 executing one or more algorithms. For example, when the idle period is indicated in the duration field, the processing system 710 may determine to sleep for a time indicated by the idle period. Thereafter, the transmitter 715 may be executed by the processing system 710 to refrain from performing a transmission during the idle period. In another aspect, means for determining whether the control frame type was successfully indicated to an AP based on the ACK identification extension may comprise the processing system 710 executing one or more algorithms. For example, when the ACK frame is received from the AP, the processing system may determine that the ACK identification extension is included in the duration field of the ACK frame. Thereafter, the processing system 710 may determine whether the control frame type was successfully indicated to the AP by comparing the ACK ID extension to a bit sequence derived from a receiver address (RA) and transmitter address (TA) of the control frame type.

As used herein, the term “defining” encompasses a wide variety of actions. For example, “defining” may include resolving, selecting, choosing, establishing, and the like.

As used herein, a phrase referring to “at least one of” a list of items refers to any combination of those items, including single members. As an example, “at least one of: A, B, or C” is intended to cover: A or B or C, or A and B, or A and C, or B and C, or A, B and C, or 2A, or 2B, or 2C, and so on.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. An apparatus for wireless communication using a control frame, comprising:
a processing system configured to:
indicate first information via a field of the control frame, and
indicate second information different from the first information via the field; and
an interface configured to provide the control frame for transmission.

2. The apparatus of claim 1, wherein the first information is a preferred modulation and coding scheme (MCS), the second information is a control frame type, and the field comprises a set of values, the processing system configured to:
indicate the preferred MCS via a first subset of the set of values; and
indicate the control frame type via a second subset of the set of values.

3. The apparatus of claim 2, wherein the control frame type facilitates reception of an acknowledgment (ACK) frame, the apparatus further comprising:
a second interface configured to receive the ACK frame based on a transmission of the control frame.

4. The apparatus of claim 3, wherein the ACK frame comprises a duration field indicating at least one of an idle period or an ACK identification extension, wherein the processing system is configured to:
refrain from performing a transmission during the idle period if the duration field indicates the idle period; and
determine whether the control frame type was successfully indicated based on the ACK identification extension if the duration field indicates the ACK identification extension.

5. The apparatus of claim 1, wherein the first information is an uplink data indication (UDI), the second information is a control frame type, and the field comprises a set of values, the processing system configured to:
indicate the UDI via a first subset of the set of values; and
indicate the control frame type via a second subset of the set of values.

6. The apparatus of claim 5, wherein the control frame type indicates an operating channel offset.

7. The apparatus of claim 1, wherein the second information is a control frame type and the field comprises a set of bits, the processing system further configured to:
define a subset of the set of bits for indicating the first information; and
indicate the control frame type via at least one bit of the set of bits that are not in the defined subset.

8. The apparatus of claim 7, wherein the subset of the set of bits is defined based on a number of values associated with the first information.

9. The apparatus of claim 7, wherein the first information is an uplink data indication (UDI) and the set of bits comprises 12 bits, the processing system configured to:
define 10 of the 12 bits for indicating the UDI; and
indicate the control frame type via two of the 12 bits that are not defined for indicating the UDI.

10. The apparatus of claim 9, wherein the 10 of the 12 bits are defined based on a number of values associated with the UDI.

11. The apparatus of claim 7, wherein the first information is a preferred modulation and coding scheme (MCS) and the subset of bits comprises at least three bits, the processing system configured to:
define one bit for indicating the preferred MCS and indicate the control frame type via two bits that are not defined for indicating the preferred MCS; or
define two bits for indicating the preferred MCS and indicate the control frame type via one bit that is not defined for indicating the preferred MCS.

12. The apparatus of claim 11, wherein the one bit or two bits are defined based on a number of values associated with the preferred MCS.

13. The apparatus of claim 1, wherein the second information is an indication of a channel to be used for communication and the field comprises a set of values, the processing system configured to:
indicate the first information via a first subset of the set of values; and
indicate the channel to be used for communication via a second subset of the set of values,
wherein the first information comprises a preferred modulation and coding scheme (MCS) or an uplink data indication (UDI).

14. A method for wireless communication using a control frame, comprising:
indicating first information via a field of the control frame;
indicating second information different from the first information via the field; and
providing the control frame for transmission.

15. The method of claim 14, wherein the first information is a preferred modulation and coding scheme (MCS), the second information is a control frame type, and the field comprises a set of values, the method comprising:
indicating the preferred MCS via a first subset of the set of values; and
indicating the control frame type via a second subset of the set of values.

16. The method of claim 15, wherein the control frame type facilitates reception of an acknowledgment (ACK) frame, the method further comprising:
receiving the ACK frame based on a transmission of the control frame.

17. The method of claim 16, wherein the ACK frame comprises a duration field indicating at least one of an idle period or an ACK identification extension, the method further comprising:
refraining from performing a transmission during the idle period if the duration field indicates the idle period; and
determining whether the control frame type was successfully indicated based on the ACK identification extension if the duration field indicates the ACK identification extension.

18. The method of claim 14, wherein the first information is an uplink data indication (UDI), the second information is a control frame type, and the field comprises a set of values, the method comprising:
indicating the UDI via a first subset of the set of values; and
indicating the control frame type via a second subset of the set of values.

19. The method of claim 18, wherein the control frame type indicates an operating channel offset.

20. The method of claim 14, wherein the second information is a control frame type and the field comprises a set of bits, the method further comprising:
defining a subset of the set of bits for indicating the first information; and
indicating the control frame type via at least one bit of the set of bits that are not in the defined subset.

21. The method of claim 20, wherein the subset of the set of bits is defined based on a number of values associated with the first information.

22. The method of claim 20, wherein the first information is an uplink data indication (UDI) and the set of bits comprises 12 bits, the method comprising:
defining 10 of the 12 bits for indicating the UDI; and
indicating the control frame type via two of the 12 bits that are not defined for indicating the UDI,
wherein the 10 of the 12 bits are defined based on a number of values associated with the UDI.

23. The method of claim 20, wherein the first information is a preferred modulation and coding scheme (MCS) and the subset of bits comprises at least three bits, the method comprising:
defining one bit for indicating the preferred MCS and indicating the control frame type via two bits that are not defined for indicating the preferred MCS; or
defining two bits for indicating the preferred MCS and indicating the control frame type via one bit that is not defined for indicating the preferred MCS,
wherein the one bit or two bits are defined based on a number of values associated with the preferred MCS.

24. The method of claim 14, wherein the second information is an indication of a channel to be used for communication and the field comprises a set of values, the method comprising:
indicating the first information via a first subset of the set of values; and
indicating the channel to be used for communication via a second subset of the set of values,
wherein the first information comprises a preferred modulation and coding scheme (MCS) or an uplink data indication (UDI).

25. An apparatus for wireless communication using a control frame, comprising:
a processing system configured to:
determine a set of bits in a field of the control frame associated with first information,
define a subset of the set of bits for indicating the first information, and
indicate second information different from the first information via at least one bit of the set of bits that are not in the defined subset; and
an interface configured to provide the control frame for transmission.

26. The apparatus of claim 25, wherein:
the set of bits is determined based on a number of bits available in the field; and
the subset of the set of bits is defined based on a number of values associated with the first information.

27. The apparatus of claim 25, wherein the control frame is a null data packet (NDP) power save (PS)-poll frame.

28. A method for wireless communication using a control frame, comprising:
determining a set of bits in a field of the control frame associated with first information;
defining a subset of the set of bits for indicating the first information;
indicating second information different from the first information via at least one bit of the set of bits that are not in the defined subset; and
providing the control frame for transmission.

29. The method of claim 28, wherein:
the set of bits is determined based on a number of bits available in the field; and
the subset of the set of bits is defined based on a number of values associated with the first information.

30. The method of claim 28, wherein the control frame is a null data packet (NDP) power save (PS)-poll frame.
